(19) United States
(12) Patent Application Publication
(10) Pub. No.: US 2008/0293874 A1
(43) Pub. Date: Nov. 27, 2008

(54) Polymers for the Dispersion of Pigments and Fillers

(75) Inventors: Matthias Schrod, Eppertshausen (DE); Dominika Malyska, Oberneuhausen (DE); Silvia Braun, Moosburg (DE)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignee: SUD-CHEMIE AG, Munchen (DE)

(21) Appl. No.: 11/912,337

(22) PCT Filed: Apr. 26, 2006
(86) PCT No.: PCT/EP2006/003880

§ 371 Date: Jun. 16, 2008

(30) Foreign Application Priority Data
Apr. 26, 2005 (DE) 10 2005 019 384.6

(51) Int. Cl. C08F 118/02; C08F 8/00; C09D 119/00

(52) U.S. Cl. 524/556; 526/319; 525/55

(57) ABSTRACT

The invention relates to a polymer of the formula (I)

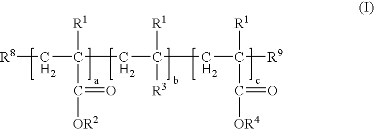

where R¹ to R⁹ and the indices A, B, C, M, and N have the definitions stated in claim 1. The polymer of the invention is suitable in particular as a dispersant for pigments or fillers in paints.

The invention relates to a polymer which can be used as a dispersant, to a process for preparing the polymer, and to the use of the polymer as a dispersant, more particularly for pigments and fillers, in pigment pastes, for example, and also coating compositions, such as inks and paints.

In order to obtain a homogeneous application of color and also a high color strength in coating compositions, pigment particles which are present in these compositions must form a stable dispersion, i.e., must be distributed homogeneously and in the form of very small primary particles. To this end the dispersed pigment particles must on the one hand be wetted effectively by the solvent, and on the other hand the pigment particles must be hindered from reagglomeration, so that the formation of larger agglomerates, which quickly sink within the solvent, is suppressed. The surface of pigment particles or of the fillers used in the coating composition may range from very polar to very nonpolar. In order to make the particles compatible with the solvent or binder, therefore, dispersants are used. These dispersants must interact on the one hand on the surface of the particle and on the other hand with the solvent, in order to improve the wettability of the particles and to allow the formation of a stable dispersion. The dispersant must therefore have regions in the molecule which are highly compatible with the solvent or binder. Where organically based systems are used, it is possible, for example, to provide hydrophobic structures, such as alkyl, polyester or aryl groups, in the molecule of the dispersant. In an aqueous system the compatibilizing segment is typically composed of polyethylene glycols or of polymerized monomers having (salified) carboxylic acid groups. For example, the polar surface of an inorganic pigment particle may be covered with a polymer that has polar segments, which bind to the polar surface of the particle, and also nonpolar regions, which bring about compatibility with the solvent. Polar regions can be produced, for example, by providing (tertiary) amino groups, phosphoric ester groups or carboxylic acid groups in the polymer. The polar surface of the pigment particle, therefore, is coated with a shell which has less polar properties in comparison to the surface of the pigment particle. The surface of the pigment particles therefore becomes more like the solvent or binder in its polarity. In this way the pigment particles can be wetted and dispersed by the solvent so that they are in a homogeneous and finely divided form, do not float on the solvent and do not settle. In most cases the polymer also includes sterically bulky groups, whose steric hindrance hinders agglomeration of the individual pigment particles.

EP 1197 536 A2 describes a composition which can be used as a dispersant for pigments. The composition comprises a graft polymer which has an average molecular weight of about 5000-100 000 and that comprises a polymer backbone and also, going out from the backbone, anionic and nonionic hydrophilic side chains. In comparison to the side chains, the polymer backbone has hydrophobic properties and contains polymerized ethylenically unsaturated hydrophobic monomers and, based on the total weight of the polymer backbone, a fraction of up to 30% by weight of polymerized ethylenically unsaturated monomers which carry functional groups that are able to strengthen the binding force to pigments. The anionic side chains are formed by hydrophilic macromonomers which are prepared from polymerized ethylenically unsaturated monomers and which, based on the total weight of the anionic side chain, contain 2%-100% by weight of a polymerized ethylenically unsaturated acidic monomer. The nonionic side chains are formed by hydrophilic ethylenically unsaturated macromonomers which contain polyalkylene glycols.

EP 1 081 169 A1 describes branched polymers which derive from the following monomer mixture:
(A) 50% to 93% by weight of at least one ethylenically unsaturated monomer,
(B) 2% to 25% by weight of at least one ethylenically unsaturated macromonomer having a molecular weight of 1000 to 20 000, and
(C) 5% to 25% by weight of at least one polymerizable imidazole derivative,
   components (A), (B) and (C) together making 100%, and the polymer having a molecular weight of 15 000 to 100 000 and being in salt form where appropriate. The polymer can be used as a dispersant for the production of inks and paints.

EP 1 293 523 A2 describes a water-based pigment dispersion which can be used for preparing aqueous compositions for coatings and which comprises a dispersed pigment, an aqueous vehicle, and, as dispersant, a branched polymer. The polymer used as the dispersant has a weight-averaged molecular weight of about 5000 to 100 000 and comprises 20% to 80% by weight of a hydrophilic backbone and 80% to 20% by weight of macromonomeric side chains. Based on the weight of the backbone, the backbone consists of 70% to 98% by weight of polymerized ethylenically unsaturated monomers which contain no carboxyl groups, and of 2% to 30% by weight of polymerized ethylenically unsaturated monomers which carry a carboxyl group, at least 10% of the carboxyl groups having been neutralized with an amine or with an inorganic base. In comparison to the side chains, the backbone has hydrophilic properties. The side chains are composed of macromonomers of polymerized ethylenically unsaturated monomers which have been copolymerized into the macromonomer via an ethylenically unsaturated group provided on the macromonomer, the macromonomers having a molecular weight of 1000 to 30 000. The monomers of the backbone and also of the macromonomers which do not contain carboxyl groups are selected from the group consisting of alkyl acrylates, alkyl methacrylates, cycloaliphatic acrylates, aryl acrylates, aryl methacrylates, styrene, alkylstyrene, acrylonitrile, hydroxyalkyl acrylates, hydroxyalkyl methacrylates, and mixtures thereof. The ethylenically unsaturated monomers of the backbone which carry carboxyl groups are selected from the group consisting of acrylic acid and methacrylic acid. The alkyl and aryl groups and also the cycloaliphatic groups each comprise 1 to 12 carbon atoms. The ratio of pigment to polymer, based on the weight, is between 1/100 and 200/100. The branched polymer present as dispersant contains 5% to 40% by weight of a monomer that carries hydroxyl groups. At a high shear rate (1000 s⁻¹) the water-based pigment dispersion has a viscosity of 10 to 1000 mPas, as measured using a Rotovisco viscometer.

EP 0 311 157 A1 describes a polymer that can be used as a dispersant. It is composed of (A) 0 to 80 mol % of a styrene derivative, (B) 0 to 70 mol % of an acrylate derivative or methacrylate derivative, (C) 5 to 50 mol % of a monomer that contains a heterocyclic group which includes at least one basic nitrogen atom in the ring, (D) 0-10 mol % of a monomer that comprises a group which can bring about crosslinking or coupling, and 0 to 20 mol % of a monomer which does not fall within groups (A) to (D), the fraction of the monomers from group (A) and the monomers containing acrylate groups making up at least 20 mol %.

Coating systems usually comprise a multiplicity of components in solid or liquid phase, it being necessary for the individual constituents to be harmonized with one another in such a way that the system does not undergo separation. Furthermore, it is desired that the pigments included be utilized as effectively as possible, so that effective color strength and hiding are achieved with just small amounts of the color paste or paint. Moreover, the color system must have an appropriate viscosity so that it is easy to use and permits uniform application. For a particular system, therefore, it is necessary in each case to determine, individually, a suitable dispersant for the pigment particles and/or fillers, in order to give a coating system as close as possible to the ideal. Although there is already a whole range of dispersants known for use in coating systems, therefore, there continues to be a need for new dispersants which allow further optimization of the harmonization of paint systems.

A first object on which the invention was based was therefore that of providing a polymer which is suitable as a dispersant in, for example, ink, paint, and other coating systems.

This object is achieved with a polymer of the formula (I):

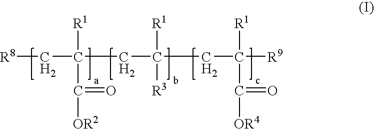

where the definitions of the radicals and indices are as follows:
R¹: in each case independently of one another: H, or an alkyl group having 1 to 6 carbon atoms;
R²: H, an alkyl group having 1 to 8 carbon atoms, an alkali metal ion, an alkaline earth metal ion, an ammonium ion or the radical of any other base;
R³: an aryl group or an aralkyl group having 6 to 18 carbon atoms;
R⁴:

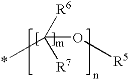

R⁵: H or an alkyl group having 1 to 6 carbon atoms;
R⁶, R⁷: in each case independently: H or methyl;
R⁸, R⁹: H or any terminal group;
a: 0.1 to 0.9;
b: 0.9 to 0.1;
c: 0.001 to 0.5;
m: 1 to 4;
n: 1 to 150.

The polymer of the invention comprises as its backbone a hydrocarbon chain which pendantly carries (salified) carboxyl groups, polyethers, and nonpolar aryl or aralkyl groups. Through the ratio of the repeating units characterized by the indices a, b and c, therefore, it is possible to fine-tune the polarity of the main chain to the surface of, say, a pigment particle which is to be coated with the polymer of the invention. For polar surfaces, the carboxyl group of the repeating unit characterized by the index a can have been converted at least in part into a carboxylate group, so that pendantly to the main chain there are negative groups attained which act as anchor groups for the anchoring of the polymer to polar surfaces of the pigment particles. Preferably, therefore, the group R² denotes a proton or an alkali metal ion or an ammonium ion, the latter groups being introduced through neutralization of the polymer with a suitable base, such as an alkali metal base or nitrogen base. Alternatively, it is possible to use any other bases suitable for neutralization of the carboxyl group.

By way of the repeating unit characterized by the index b, nonpolar groups are introduced into the polymer via the group R³. Suitability is possessed by aryl groups or aralkyl groups having 6 to 18 carbon atoms. By an aralkyl group is meant an aryl group which is substituted with at least one alkyl group or alkylene group, such as methyl group or a methylene group. With particular preference R³ is a phenyl group or is a phenyl group substituted by one or more methyl or isobutyl groups.

By way of the repeating unit characterized by the index c, long-chain polyether groups are disposed pendantly to the main polymer chain. Terminally, the polyether groups may carry a hydrogen atom or an alkyl group having 1 to 8 carbon atoms, preference being given to a proton and also to a methyl group. The polyether chain may carry methyl groups pendant with the groups R⁶ and R⁷. As pendant polyether groups it is preferred to use polyethylene oxide and polypropylene oxide, with polyethylene oxide being particularly preferred. The chain length is preferably chosen such that n adopts values between 1 and 150, preferably 5 to 45, with particular preference 10 to 25.

The polymer possesses typical terminal groups R⁸ and R⁹, which come about through the initiation of the free-radical polymerization or through chain transfer reactions or through chain termination reactions. The groups R⁸ and R⁹ may, for example, be a proton, a group which has formed from a free-radical initiator, or, for example, a sulfur-containing group which is generated by a chain transfer reagent.

The properties of the polymer can be adjusted through the fractions of the repeating units having indices a, b and c (a+b+c=1). In this context, a is selected in the range from 0.1 to 0.9, b in the range from 0.9 to 0.1, and c in the range from 0.001 to 0.5. The ranges of values for the indices are preferably 0.1 to 0.5 for a, 0.9 to 0.4 for b, and 0.001 to 0.25 for c; with particular preference, the ranges of values for the indices are from 0.2 to 0.4 for a, from 0.8 to 0.6 for b, and from 0.001 to 0.1 for c.

For each repeating unit independently, the groups R¹ are preferably a proton or a methyl group.

The molecular weight of the polymer of the invention is guided by the intended application. Preferably the molecular weight of the polymer is situated within the range from 1000 to 100 000 u, preferably 2000 to 50 000 u, with particular preference 4000 to 20 000 u.

Besides the repeating units shown in formula (I), the polymer of the invention may have further repeating units as well. These further repeating units can be used where appropriate to undertake fine-tuning of the polymer.

The polymer of the invention can be prepared by typical polymerization processes.

The invention accordingly also provides a process for preparing a polymer of the formula I, which involves subjecting monomers of the formulae (III) to (V) in a ratio a:b:c to free-radical polymerization,

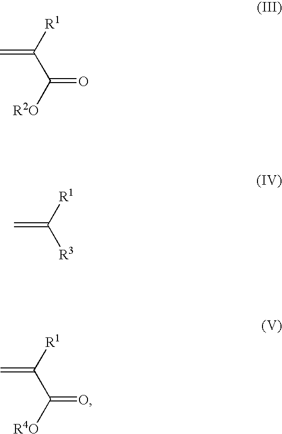

R¹, R², R³, R⁴, a, b, and c having the definitions stated above.

The free-radical polymerization may per se be carried out in bulk. For that purpose, portions or the entirety of the starting components are included as an initial charge and a typical free-radical initiator is added in order to set in motion the free-radical polymerization. As free-radical initiators, it is possible to add typical compounds, such as azo compounds or peroxides. Examples of suitable free-radical initiators are dibenzoyl peroxide or azoisobutyronitrile, dilauroyl peroxide, tert-butyl peroxybenzoate, and dicumyl peroxide. Alternatively the free-radical reaction can be initiated by means of high-energy radiation, such as UV radiation, or else by strong heating. Furthermore, it is possible during the polymerization to add typical compounds, in order, for example, to set the desired chain length. Use is suitably made, for example, of chain transfer reagents, such as mercaptans, halogenated hydrocarbons, aldehydes, ketones, and alcohols, for example.

Particularly for preparation on the industrial scale, the reaction is carried out preferably in a suitable solvent, preferably at boiling temperature under reflux. Examples of suitable solvents include alcohols such as methanol, ethanol, or isopropanol, ketones, such as acetone or butanone, ether compounds, such as tetrahydrofuran, diethyl ether or methyl tert-butyl ether, and ester compounds, such as ethyl acetate or butyl acetate. Suitable solvents may be determined by the skilled person by means of corresponding serial experiments. The solvent may where appropriate also include water. The amount of water in that case can be between 0% and 50% by weight, based on the amount of solvent.

The polymerization can be carried out batchwise: that is, the reactants are introduced in a reaction vessel at the beginning of the reaction, and the reaction is initiated by addition of a free-radical initiator. An alternative option is to carry out the reaction in a feed process, with some or all of the reactants being introduced into the reaction vessel in the course of the reaction.

After the end of the polymerization reaction the solvent can be removed by distillation and the polymer obtained can be processed further in a customary way.

With particular preference the polymer is neutralized following preparation. In that case the group R² in the compound of the formula (III) corresponds to a proton, which through neutralization is replaced with a corresponding base cation. The polymer is neutralized with typical basic compounds, such as alkali(ne earth) metal hydroxides, more particularly aqueous sodium hydroxide solution, or suitable amino compounds. Neutralization is accomplished preferably with aqueous sodium hydroxide solution. After that the solvent is removed by distillation, the distillation being carried out preferably under reduced pressure in order to minimize the thermal load on the polymer. At the distillation stage, the solvent and any remaining monomers are removed, completely as far as possible. Besides the monomers already specified, it is also possible for further free-radically polymerizable monomers to be added in the reaction mixture. Suitable examples include allyl compounds, such as allyl ethers or allyl acetates, and vinyl compounds, such as vinyl acetate.

The invention further provides the use of the above-described polymer as a dispersant. As has already been elucidated, the polymer of the invention comprises a main chain whose polarity can be attuned and brought up to the polarity of the surface. Further, the polymer of the invention comprises long-chain pendant polyether chains, which through steric hindrance prevents agglomeration of the particles coated with the polymer of the invention; the stabilization of the dispersion is also assisted by the presence of ionic groups in monomers of the formula III, which bring about electrostatic repulsion. The polymer of the invention is especially suitable as a dispersant for pigments and fillers. Exemplary pigments are TiO₂, Fe₂O₃, BaSO₄, Cr₂O₃, or else mica particles, which may have been coated with titanium dioxide or iron oxide, for example, or else aluminum flakes. Besides inorganic pigments, the polymer according to the invention may also be used as a dispersant for organic pigments, such as copper phthalocyanines, azo pigments, quinacridone pigments or diketopyrrolopyrrole pigments. The polymer of the invention is also suitable, moreover, as a dispersant for fillers, such as barium sulfate, for example.

The invention is elucidated in more detail below, by means of examples, and with reference to the attached figures.

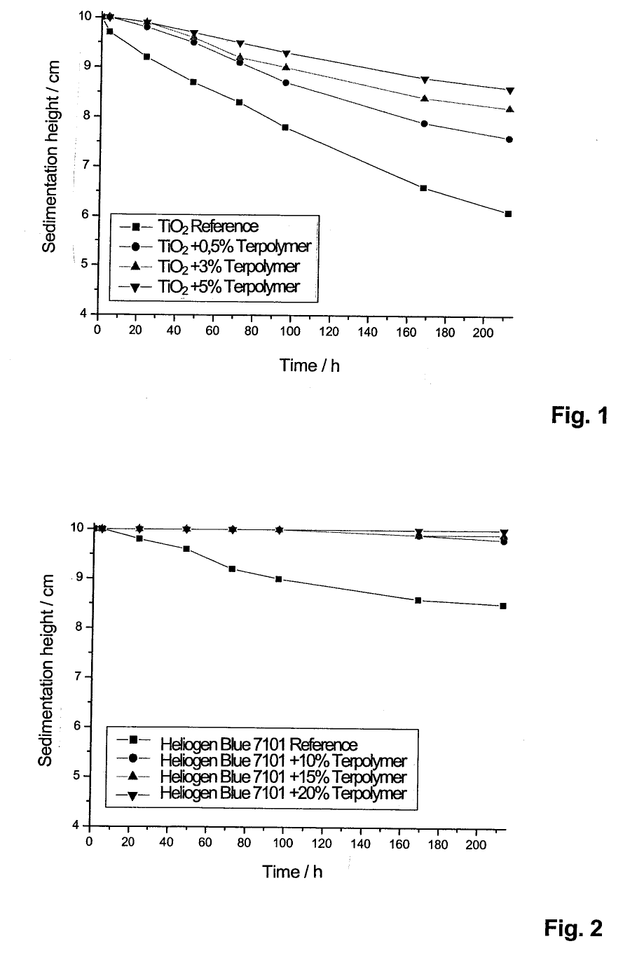

FIG. 1: shows a graphical representation of the results of a sedimentation test on TiO₂, the test having been carried out with or without addition of the polymer of the invention;

FIG. 2: shows a graphical representation of the results of a sedimentation test on copper phthalocyanine, the test having been carried out with or without addition of the polymer of the invention;

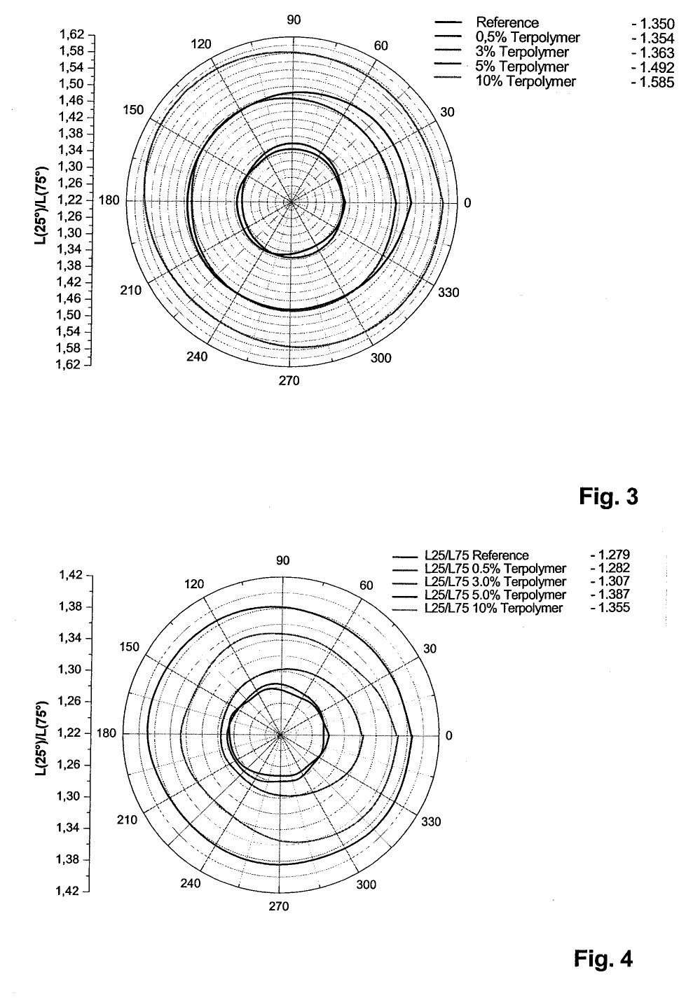

FIG. 3: shows a graphical representation of the orientation parameters for Iriodin® 225 in an aqueous acrylate varnish on addition of the polymer of the invention;

FIG. 4: shows a graphical representation of the orientation parameters for Iriodin® 225 in a solvent-containing polyurethane varnish on addition of the polymer of the invention.

### EXAMPLE 1

A 1-liter three-neck flask which had been provided with a thermometer, a nitrogen port, and an intensive condenser was used to dissolve 291.8 g of styrene, 603.3 g of methacrylic acid, and 209.8 g of methoxypolyethylene glycol methacrylate (1000 g/mol) (MPEG 1000 MA) (50% in H₂O) in tetrahydrofuran, with stirring. Then 30.2 g of dibenzoyl peroxide (75% in H₂O) were added and the contents of the flask were conditioned at 65° C. under a gentle stream of nitrogen. The mixture was heated under reflux for 18 hours. After that it was cooled approximately to room temperature. With vigorous stirring, in portions, 73.75 g of solid NaOH and 1.25 l of deionized water were added. After the contents of the flask had dissolved again, tetrahydrofuran, water, and unreacted styrene were removed by distillation under reduced pressure. The pressure at this point was chosen such that the temperature of the mixture did not exceed 40° C. The concentrated polymer solution was adjusted with water to a solids content of approximately 33% by weight.

### EXAMPLE 2

To test the stabilizing effect with respect to TiO₂ and copper phthalocyanine pigments, the polymer obtained in example 1 was used at different concentrations in aqueous 1% pigment dispersions. TiO₂ and copper phthalocyanine were dispersed in water, with and without addition of polymer, and with addition of ZrO₂ beads, in a dispersing apparatus for 30 minutes, after which the sedimentation was analyzed under laboratory conditions. This analysis involved measuring the height of sedimentation as a function of the time. The results for the sedimentation analyses with TiO₂ are set out in FIG. 1, and the results of the sedimentation test on copper phthalocyanine are set out in FIG. 2.

Through the addition of the polymer according to the invention it was possible to retard the sedimentation of the pigments. The degree of stabilization is also dependent on the concentration of the polymer.

### EXAMPLE 3

The influencing of the orientation of effect frequencies in paints was investigated using Iriodin® 225 (Merck KGaA, Darmstadt) as the example. The pigment was stirred at 800 rpm for an hour with aqueous solutions of the polymer obtained in example 1, using polymer solutions at different concentrations (0.5%, 3%, 5%, and 10%, based on the pigment). The pigment was subsequently removed by filtration, dried, and incorporated by stirring at 1000 rpm into a water-based varnish (1K Hydroplast Economy Acrylatlack®, Klumpp) and a solvent-containing varnish (Cerami Clear PU-Klacklack®, PPG) at a concentration of 10% by weight, based on the solids content, for 20 minutes. The paint samples prepared were applied by spraying to Leneta® contrast plates, with a dry film thickness of 10±5 μm. For the quantitative assessment of the orientation of the pigment platelets, the orientation parameter L25/L75 was used, L25 and L75 being determined by colorimetry at angles at 250 and 750, by a gyroscopic method. The larger and more uniform the orientation parameter, the better the horizontal orientation of the pigment particles. In the ideal case the values of the orientation parameter form a circle. The results of the orientation parameter measurements conducted are set out in FIGS. 3 and 4.

From FIGS. 3 and 4 it is apparent that the orientation of the particles of a pearlescent pigment can be influenced efficiently, both in aqueous and in a solvent-containing varnish, through the treatment of the pigment with the polymer of the invention. As the concentration of the polymer increases relative to the pigment, a horizontal orientation of the pigment particles is increasingly induced.

1. A polymer having the formula (I) 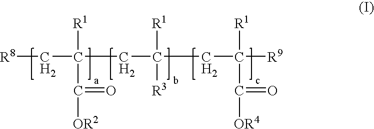
where the definitions of the radicals and indices are as follows:
R¹: H, or an alkyl group having 1 to 6 carbon atoms;
R²: H, an alkyl group having 1 to 8 carbon atoms, an alkali metal ion, an alkaline earth metal ion, or an ammonium ion or the radical of any other base;
R³: an aryl group or an aralkyl group having 6 to 18 carbon atoms;
R⁴: 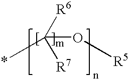
R⁵: H or an alkyl group having 1 to 6 carbon atoms;
R⁶, R⁷: H or a methyl group;
R⁸, R⁹: H or any terminal group;
a: 0.1 to 0.9;
b: 0.9 to 0.1;
c: 0.001 to 0.5;
m: 1 to 4; and
n: 1 to 150.

2. The polymer of claim 1, having a molecular weight in the range from 1000 to 100 000.

3. A process for preparing the polymer of formula I of claim 1, by subjecting monomers of the formulae (III) to (V) in a ratio of a:b:c to free-radical polymerization, wherein the monomers have the following formula: 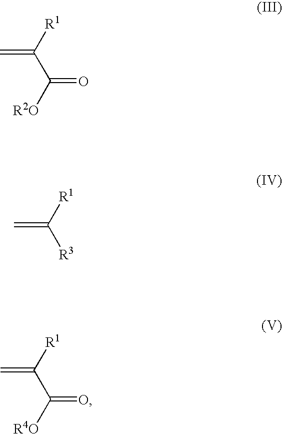
wherein R¹, R², R³, R⁴, a, b and c have the definitions stated in claim 1.

4. The process of claim 3 wherein the free-radical polymerization is carried out in a solvent under reflux.

5. The process of claim 3, where R² is a hydrogen atom and, after the free-radical polymerization, a base is added to convert the carboxylic acid group of the repeating unit from the monomer of the formula (III) into a carboxylate.

6. A dispersant comprising the polymer of claim 1.

7. Pigments and fillers comprising the polymer of claim 1.

8. A coating composition, paste and/or molding compound comprising the polymer of claim 1.

9. The polymer of claim 1 wherein a+b+c=1.

10. The polymer of claim 1 wherein
R²: H, an alkali metal ion, an alkaline earth metal ion, an ammonium ion or the radical of any other base.

11. The process of claim 3 wherein a+b+c=1.

12. A polymer having the formula (I) 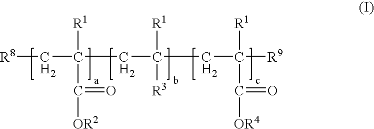
where the definitions of the radicals and indices are as follows:
R¹: H, or an alkyl group having 1 to 6 carbon atoms;
R²: H, an alkali metal ion, an alkaline earth metal ion, an ammonium ion or the radical of any other base;
R³: an aryl group or an aralkyl group having 6 to 18 carbon atoms;
R⁴: 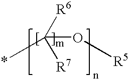
R⁵: H or an alkyl group having 1 to 6 carbon atoms;
R⁶, R⁷: H or a methyl group;
R⁸, R⁹: H or any terminal group;
a: 0.1 to 0.9;
b: 0.9 to 0.1;
c: 0.001 to 0.5;
a+b+c: 1
m: 1 to 4;
n: 1 to 150.

13. The polymer of claim 1, having a molecular weight in the range from 1000 to 100,000.
